(19) United States
(12) Patent Application Publication
(10) Pub. No.: US 2026/0122430 A1
(43) Pub. Date: Apr. 30, 2026

(54) ELECTRONIC EQUIPMENT, SYSTEM, METHOD, AND PROGRAM

(71) Applicant: CASIO COMPUTER CO., LTD., Tokyo (JP)

(72) Inventor: Koji TORIYAMA, Tokyo (JP)

(73) Assignee: CASIO COMPUTER CO., LTD., Tokyo (JP)

(21) Appl. No.: 19/331,030

(22) Filed: Sep. 17, 2025

(30) Foreign Application Priority Data
Sep. 17, 2024 (JP) 2024-160131
Jun. 12, 2025 (JP) 2025-098279

(51) Int. Cl. H04R 25/00

(52) U.S. Cl. CPC H04R 25/43; H04R 25/554; H04R 25/558; H04R 2225/31; H04R 2225/41; H04R 2460/03

(57) ABSTRACT

An electronic equipment includes at least one processor. The at least one processor intermittently performs detection processing of detecting a level of an input external sound, and performs output processing of adjusting the input external sound and outputting the input external sound in response to the external sound whose level is equal to or higher than a first level being detected in consecutive executions of the detection processing performed intermittently.

### CROSS-REFERENCE TO RELATED APPLICATIONS

This application claims priority based on Japanese Patent Application No. 2024-160131 filed on Sep. 17, 2024 and Japanese Patent Application No. 2025-098279 filed on Jun. 12, 2025, the entire contents of which are incorporated herein.

### TECHNICAL FIELD

The present disclosure relates to an electronic equipment, a system, a method, and a recording medium.

### BACKGROUND

A constantly worn electronic equipment such as a hearing aid equipment is required to reduce power consumption so as to be able to operate for a long time on a single charge. The hearing aid equipment is, for example, a hearing aid, a sound amplifier, or a hearing assistance device. For example, a hearing aid described in JP H05-344595 A constantly detects a level of input sound, and turns off a hearing aid function when no sound exceeding a certain level is input, to reduce power consumption.

### SUMMARY

An electronic equipment according to an embodiment of the present disclosure includes at least one processor. The at least one processor intermittently performs: detection processing of detecting a level of an input external sound, and performs output processing of adjusting the input external sound and outputting the input external sound in response to the external sound whose level is equal to or higher than a first level being detected in consecutive executions of the detection processing performed intermittently.

### BRIEF DESCRIPTION OF THE DRAWINGS

FIG. 1 is a block diagram showing a configuration of a hearing aid equipment according to an embodiment of the present disclosure;

FIG. 2 is a diagram showing an outline of an operation of a hearing aid equipment in a first embodiment of the present disclosure;

FIG. 3 is a diagram showing an outline of an operation of the hearing aid equipment in the first embodiment of the present disclosure;

FIG. 4 is a diagram showing an outline of an operation of the hearing aid equipment in the first embodiment of the present disclosure;

FIG. 5 is a flowchart showing processing performed by the hearing aid equipment in the first embodiment of the present disclosure;

FIG. 6 is a flowchart showing processing performed by a hearing aid equipment in a second embodiment of the present disclosure; and

FIG. 7 is a sequence diagram showing processing performed by a system including a hearing aid equipment and an external equipment in a third embodiment of the present disclosure.

### DETAILED DESCRIPTION

The following description relates to an electronic equipment, a system, a method, and a program according to an embodiment of the present disclosure. Common or corresponding elements are denoted by the same or similar reference signs, and redundant description is appropriately simplified or omitted.

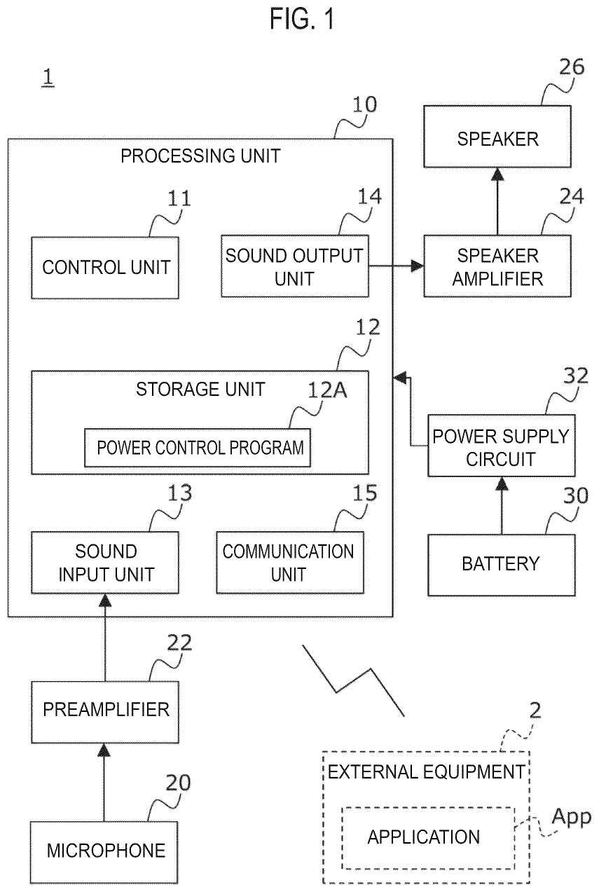

A hearing aid equipment 1 shown in FIG. 1 is an example of an electronic equipment. The hearing aid equipment 1 is, for example, a hearing aid. For example, a user uses the hearing aid equipment 1 worn on the right ear or the left ear diagnosed to have a hearing loss. When both the ears are diagnosed to have a hearing loss, a user uses a pair of hearing aid equipment 1 worn on the respective ears. The hearing aid equipment 1 may be a sound amplifier or a hearing assistance device.

The hearing aid equipment 1 is an example of a computer. As shown in FIG. 1, the hearing aid equipment 1 includes a processing unit 10, a microphone 20, a preamplifier 22, a speaker amplifier 24, a speaker 26, a battery 30, and a power supply circuit 32. The power supply circuit 32 supplies power from the battery 30 to each unit of the hearing aid equipment 1. As a result, the hearing aid equipment 1 operates. FIG. 1 merely shows an example of a configuration of the hearing aid equipment 1. The hearing aid equipment 1 may include other elements not shown in FIG. 1. The hearing aid equipment 1 may be configured not to include some of the elements shown in FIG. 1. For example, the microphone 20, the preamplifier 22, and a sound input unit 13 described below may be replaced with a digital microphone that outputs a pulse density modulation (PDM) signal. The digital microphone may be mounted on the processing unit 10 or may be an external type connected to the processing unit 10. The speaker amplifier 24 and a sound output unit 14 described below may be replaced with a class-D amplifier that outputs a pulse width modulation (PWM) signal. The class-D amplifier may be mounted on the processing unit 10 or may be an external type connected to the processing unit 10.

The processing unit 10 is, for example, a system on a chip (SoC) including a central processing unit (CPU), a digital signal processor (DSP), a memory, a communication interface, and the like. The processing unit 10 may be implemented by a circuit of another form such as a system in package (Sip). The processing unit 10 includes a control unit 11, a storage unit 12, the sound input unit 13, the sound output unit 14, and a communication unit 15 as functional blocks.

The control unit 11 is implemented by, for example, at least one processor such as a CPU or a DSP. The control unit 11 reads various programs and various data stored in the storage unit 12 to comprehensively control the hearing aid equipment 1.

The storage unit 12 includes, as a storage device, a nonvolatile semiconductor memory such as a flash memory, an erasable programmable read only memory (EPROM), or an electrically erasable programmable ROM (EEPROM). The storage unit 12 stores various programs and various data. For example, the control unit 11 executes a power control program 12A stored in the storage unit 12 to perform various types of processing according to an embodiment of the present disclosure.

The sound input unit 13 includes, for example, an analog/digital (A/D) converter. The sound input unit 13 converts an analog sound signal input via the microphone 20 and the preamplifier 22 into a digital sound signal. The sound input unit 13 may acquire a value of an instantaneous voltage generated in the microphone 20, instead of a value (AD value) obtained by performing AD conversion on information regarding an external sound.

The control unit 11 performs sound adjustment processing (such as amplification processing according to a gain for each frequency) on the digital sound signal acquired by the sound input unit 13 based on a set value (such as the gain for each frequency). The set value is set in advance based on, for example, fitting work by the user himself/herself or a hearing technician, and is stored in the storage unit 12.

The control unit 11 outputs the digital sound signal after the adjustment processing. Specifically, the sound output unit 14 includes a digital/analog (D/A) converter. The sound output unit 14 converts the digital sound signal adjusted by the control unit 11 into an analog sound signal and outputs the analog sound signal to the speaker amplifier 24. The analog sound signal amplified by the speaker amplifier 24 is output as a sound from the speaker 26.

The communication unit 15 includes a communication interface for communicating with an external equipment 2. The communication unit 15 connects the hearing aid equipment 1 and the external equipment 2 so as to be able to communicate with each other according to a radio communication standard such as Wi-Fi, Bluetooth (registered trademark), or infrared (IR) communication. The external equipment 2 connected to the hearing aid equipment 1 is, for example, a smartphone, a tablet terminal, or a personal computer (PC). The external equipment 2 may be a server placed on a network. The communication unit 15 receives, for example, a set value acquired by fitting work using the external equipment 2. The control unit 11 stores the received set value in the storage unit 12.

The hearing aid equipment 1 is, for example, an open-fit hearing aid for people with mild to moderate hearing loss. Unlike a closed-fit hearing aid, the open-fit hearing aid does not block an ear hole (ear canal). Therefore, in the open-fit hearing aid, the external sound directly reaches the ear of the user without being physically blocked. Therefore, with the open-fit hearing aid, the user can easily grasp a direction of the external sound as compared with the case of wearing the closed-fit hearing aid, and can hear the external sound to some extent even when a hearing aid function is off.

It is presumed that the hearing aid described in JP H05-344595 A is the closed-fit hearing aid. As disclosed in JP H05-344595 A, in such a type of hearing aid, it is necessary to constantly supply drive power to an input-side circuit such as a microphone in order to avoid a silent state. Therefore, in JP H05-344595 A, power consumption is high. On the other hand, since the hearing aid equipment 1 according to the present embodiment is the open-fit hearing aid, the external sound is not physically blocked. Therefore, the silent state can be avoided without constantly driving the input-side circuit such as the microphone. However, the open-fit hearing aid is positioned farther from the eardrum compared to the closed-fit hearing aid. Therefore, in the open-fit hearing aid, it is necessary to increase a gain in order to transmit a sound to the user with the same sound pressure as that of the closed-fit hearing aid. When the gain is increased, power consumption is increased, as a result of which a duration of operation on a single charge becomes shorter. Therefore, it is difficult to use the open-fit hearing aid throughout the day without charging unless a capacity of the battery is larger than that of the closed-fit hearing aid. The hearing aid is greatly restricted in size and weight for convenience of wearing on the ear of the user. It is not preferable to mount a large battery in order to increase the capacity of the battery.

In addition, in the case of a hearing aid having a true wireless stereo (TWS) earphone function capable of reproducing music, a TWS-compatible SoC for music is generally mounted. Such a type of SoC is not specifically set for hearing aids. Therefore, such a type of SoC has higher power consumption than an SoC dedicated to hearing aids. It is difficult to use the hearing aid with the TWS earphone function throughout the day without charging.

Therefore, the hearing aid equipment 1 according to the present embodiment is configured to dynamically switch an operation mode between a power saving mode and a normal operation mode according to a surrounding environment of the user. In the normal operation mode, the hearing aid function is turned on. On the other hand, in the power saving mode, the hearing aid function is turned off. As described above, in the open-fit hearing aid, the external sound directly reaches the ear of the user without being physically blocked. Therefore, for example, if the surrounding environment of the user is an environment where hearing assistance is not required, there is substantially no problem even if the normal operation mode transitions to the power saving mode to turn off the hearing aid function. Since the hearing aid equipment 1 is switched from the normal operation mode to the power saving mode as appropriate, a duration of operation on a single charge using the battery 30 becomes longer than a case where the hearing aid equipment 1 always operates in the normal operation mode.

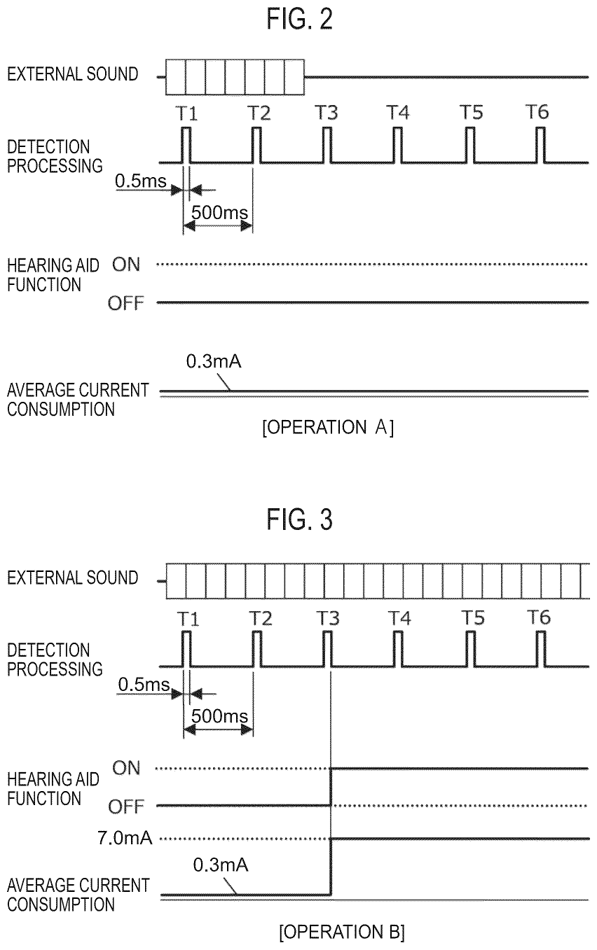

An outline of the operation of the hearing aid equipment 1 in the first embodiment of the present disclosure will be described with reference to FIGS. 2 to 4. FIGS. 2, 3, and 4 show an operation example A, an operation example B, and an operation example C, respectively. In each of FIGS. 2 to 4, in an “external sound” field, a period during which an external sound having a sound pressure level equal to or higher than a first threshold (an example of a first level) is heard (a period during which an external sound having a volume equal to or higher than a certain volume is generated around the hearing aid equipment 1) is indicated by a rectangular block. In other words, the period is a period in which the external sound having a sound pressure level equal to or higher than the first threshold (an example of the first level) can be detected if the microphone 20, the preamplifier 22, and the processing unit 10 are operating. The rectangular blocks are shown for visual clarity and do not imply that boundaries of the rectangular blocks indicate the silent state. A “detection processing” field indicates external sound detection processing that is periodically performed. A symbol (such as T1) added to the field indicates a timing at which the detection processing is performed. A “hearing aid function” field indicates an on period and an off period of the hearing aid function of the hearing aid equipment 1. An “average current” field shows an average value (unit: mA) of a current consumed by the hearing aid equipment 1. The values shown in each of FIGS. 2 to 4 are merely examples. The values appropriately vary depending on specifications of the hearing aid equipment 1.

Note that any reference to elements using designations such as “first”, “second”, and the like as used in the present disclosure does not generally limit an amount or order of those elements. These designations are used for convenience to distinguish between two or more elements. Therefore, for example, reference to first and second elements does not mean that only the two elements may be adopted, the first element must precede the second element, or the like.

In the first embodiment, the hearing aid equipment 1 performs the detection processing at a cycle of 500 ms in both the power saving mode and the normal operation mode. In the detection processing, the hearing aid equipment 1 operates the microphone 20, the preamplifier 22, and the processing unit 10 to measure five samples for the sound pressure level of the external sound at a sampling frequency of 24 kHz. A time required to measure five samples is, for example, 0.113 ms. A detection processing time is set to 0.5 ms which is sufficiently longer than 0.113 ms in consideration of overhead.

In the power saving mode, for example, a system of the hearing aid equipment 1 is stopped to be in an interrupt standby state, and power consumption is reduced. In the interrupt standby state, an operation of each unit of the hearing aid equipment 1 is substantially stopped. Specifically, in the power saving mode, the processing unit 10 operates only with a low-power clock function in order to wait for a timer interrupt as described below. In the power saving mode, the microphone 20, the preamplifier 22, the speaker amplifier 24, the speaker 26, and the power supply circuit 32 are in a sleep state. Instead of the sleep state, the microphone 20, the preamplifier 22, the speaker amplifier 24, the speaker 26, and the power supply circuit 32 may be in a standby state or may be in a power cutoff state in which power supply is completely cut off. Average current consumption in the interrupt standby state is, for example, 0.3 mA. However, even in the power saving mode, power for operation is supplied to the microphone 20, the preamplifier 22, and the processing unit 10 during the detection processing performed every 500 ms (for 0.5 ms in terms of time). Therefore, in the detection processing, the microphone 20, the preamplifier 22, and the processing unit 10 temporarily return from the sleep state (or the standby state or the power cutoff state) and operate. At this time, the sound output unit 14 still does not operate and is in the sleep state (or the standby state or the power cutoff state), and the speaker amplifier 24 and the speaker 26 are also in the sleep state (or the standby state or the power cutoff state). As a result, the average current consumption during the detection processing performed in the power saving mode is 5 mA which is higher than 0.3 mA. However, each execution of the detection processing, which is performed at the cycle of 500 ms, takes only 0.5 ms. Therefore, it is practically acceptable to assume the average current consumption during the entire period in the power saving mode, including a period of the detection processing, as 0.3 mA.

At start time points of the operation example A and the operation example B, the hearing aid equipment 1 is operating in the power saving mode. Therefore, when the hearing aid equipment 1 detects the external sound having a sound pressure level equal to or higher than the first threshold, the hearing aid equipment 1 transitions from the power saving mode to the normal operation mode and turns on the hearing aid function. However, when the hearing aid function is unnecessarily turned on due to a noise sound, not only power-saving performance is deteriorated, but also the noise sound is amplified, which may cause discomfort to the user. Therefore, in the first embodiment, when the external sound having a sound pressure level equal to or higher than the first threshold has been detected in n consecutive executions (n is a natural number of 2 or more, and n is 3 in the first embodiment) of detection processing, the hearing aid equipment 1 transitions from the power saving mode to the normal operation mode.

In the operation example A, the external sound having a sound pressure level equal to or higher than the first threshold is only detected by two executions of detection processing at timings T1 and T2. Therefore, the hearing aid equipment 1 continues to operate in the power saving mode without transitioning to the normal operation mode. The capacity of the battery 30 is, for example, 70 mAh. In a case where the hearing aid equipment 1 continuously operates in the power saving mode, the average current consumption is 0.3 mA, and thus, the hearing aid equipment 1 operates for about 233 hours after full charge. That is, the hearing aid equipment 1 can operate for a time significantly longer than one day without charging.

In the operation example B, the external sound having a sound pressure level equal to or higher than the first threshold is detected by three executions of detection processing at timings T1 to T3. Therefore, the hearing aid equipment 1 transitions from the power saving mode to the normal operation mode and turns on the hearing aid function. The user can satisfactorily hear the external sound by the hearing aid function.

Here, according to a project report “Survey Report on Daily Conversational Behavior” (URL: https://www2.ninjal.ac.jp/conversation/report/report01.pdf) of the National Institute for Japanese Language and Linguistics, an average conversation time in one day is six hours. According to 2021 media survey (https://www.nhk.or.jp/bunken/yoron-jikan/column/media-2021-05.html?v=56fb752b0c7b7ab00b5a693dle540949) of the Public Opinion Survey Division of the NHK Broadcasting Culture Research Institute, an average television viewing time in one day (weekday) is three hours. For this reason, a time for which hearing assistance is required in one day is about nine hours as a reference value. For example, even in a case where the hearing aid function is turned off during a time excluding a conversation time and a television viewing time in an activity time from wake-up to bedtime, there is substantially no problem in grasping the surrounding situation for a person with mild or moderate hearing loss, the person wearing the open-fit hearing aid.

The average current consumption in the normal operation mode is, for example, 7.0 mA. In a case where the hearing aid equipment 1 operates in the normal operation mode for nine hours (the total of the conversation time and the television viewing time) in one day, the average current consumption for 24 hours is 2.8 mA. In this case, the hearing aid equipment 1 operates for about 25 hours after full charge. That is, the hearing aid equipment 1 can operate for more than one day without charging in a state in which the hearing aid function is turned on at a timing when a person starts talking, a timing when a conversation with a person starts, or a timing when hearing assistance is required to watch TV, for example. In another point of view, the hearing aid equipment 1 can operate for more than one day without charging because the hearing aid equipment 1 operates with low power by turning off the hearing aid function at a timing when the necessity of hearing assistance is low, for example, when the surrounding environment is quiet. From still another point of view, since the power consumption is reduced, the battery 30 having a smaller capacity can be mounted. This makes it possible to achieve downsizing and weight reduction of the hearing aid equipment 1.

An execution cycle of the detection processing is not limited to 500 ms. In order to improve accuracy of a transition timing from the power saving mode to the normal operation mode, the hearing aid equipment 1 may perform the detection processing at a shorter cycle. For example, a case where the hearing aid equipment 1 performs the detection processing at a cycle of 5 ms is considered. In this case, the average current consumption in the power saving mode is, for example, 0.77 mA. In a case where the power saving mode is continued, the hearing aid equipment 1 operates for about 90 hours after full charge. In a case where the hearing aid equipment 1 operates in the normal operation mode for nine hours (the total of the conversation time and the television viewing time) in one day, the average current consumption for 24 hours is 3.1 mA. In this case, the hearing aid equipment 1 operates for about 22.6 hours after full charge. For example, when waking up at 6:00 AM and going to bed at 12:00 AM, the activity time in one day is 18 hours. That is, the hearing aid equipment 1 can operate for a time longer than the daily activity time without charging.

In order to avoid missing any sounds, it is desirable that the transition from the power saving mode to the normal operation mode is performed quickly. On the other hand, when the hearing aid function is frequently switched on and off with the mode transition, the loudness of the external sound reaching the user frequently fluctuates, which causes auditory discomfort. Therefore, in the first embodiment, in order to prevent frequent switching between on and off of the hearing aid function and to avoid missing any sounds, a condition for transitioning from the normal operation mode to the power saving mode (that is, a condition for turning off the hearing aid function) is set more strictly than a condition for transitioning from the power saving mode to the normal operation mode (that is, a condition for turning on the hearing aid function).

Specifically, as shown in the operation example C, when an external sound having a sound pressure level lower than the first threshold has been detected in m consecutive executions (m is a natural number larger than n, and m is 10 in the first embodiment) of detection processing, m executions being more than n executions, the hearing aid equipment 1 transitions from the normal operation mode to the power saving mode. As a result, the hearing aid function is prevented from being frequently switched on and off with the mode transition. By increasing the threshold for determination instead of or in addition to increasing the number of executions of detection processing, the condition for transitioning from the normal operation mode to the power saving mode (that is, the condition for turning off the hearing aid function) may be set more strictly than the condition for transitioning from the power saving mode to the normal operation mode (that is, the condition for turning on the hearing aid function).

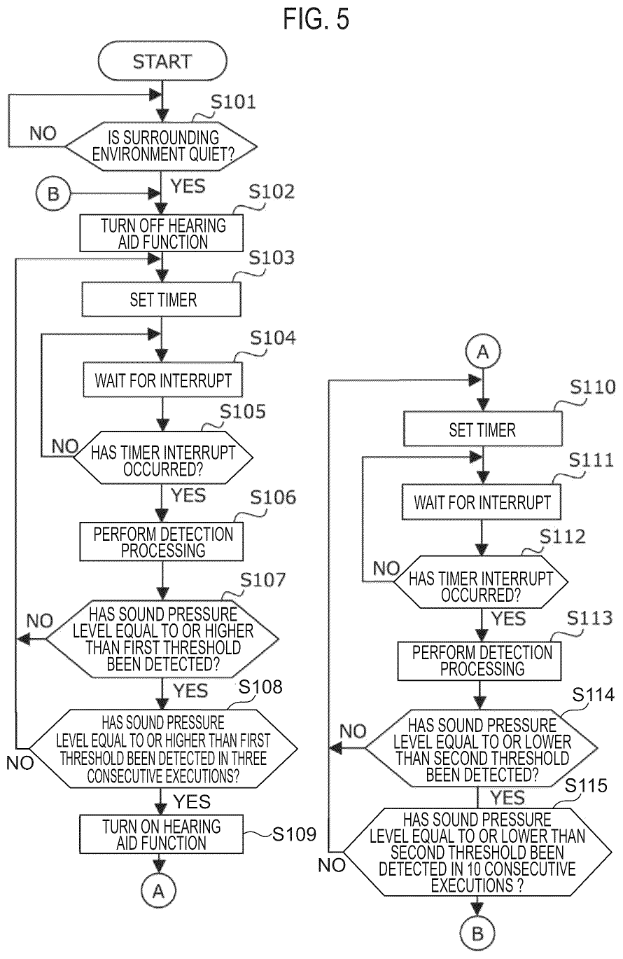

Processing performed by the processing unit 10 of the hearing aid equipment 1 in the first embodiment will be described with reference to FIG. 5. For example, when the hearing aid equipment 1 is powered on and operation in the normal operation mode is started, execution of the processing shown in FIG. 5 is started. For example, when the hearing aid equipment 1 is powered off, the processing shown in FIG. 5 ends.

The order of each step of the flowchart and the sequence shown in the embodiment of the present disclosure may be changed within a range without inconsistency. For example, in the embodiment of the present disclosure, the processing including various steps is presented using exemplary order, but the embodiment of the present disclosure is not limited to the presented order. Furthermore, the steps of the flowchart shown in the embodiment of the present disclosure may be performed simultaneously or in parallel within a range without inconsistency.

As shown in FIG. 5, the processing unit 10 determines whether or not the surrounding environment is quiet (step S101). Specifically, the processing unit 10 supplies power to the microphone 20 and the preamplifier 22 to operate the microphone 20 and the preamplifier 22. The sound input unit 13 detects, for example, via the preamplifier 22, a value (that is, the sound pressure level of the external sound) of an instantaneous voltage generated in the microphone 20.

When the sound input unit 13 detects a sound pressure level lower than the first threshold continuously for a predetermined time, the processing unit 10 determines that the surrounding environment is quiet (step S101: YES). In this case, the processing unit 10 transitions from the normal operation mode to the power saving mode and turns off the hearing aid function (step S102). The processing unit 10 does not transition to the power saving mode unless the sound input unit 13 detects a sound pressure level lower than the first threshold continuously for a predetermined time.

The processing unit 10 fades-out a sound output from the speaker 26 in order to prevent sudden fluctuations in the volume of the external sound heard by the user when transitioning from the normal operation mode to the power saving mode. That is, the processing unit 10 fades-out the adjusted external sound when transitioning from the normal operation mode (an example of a second state in which output processing of adjusting and outputting the input external sound is performed) to the power saving mode (an example of a first state in which the output processing of adjusting and outputting the input external sound is not performed).

The processing unit 10 has, for example, the low-power clock function such as a real time clock (RTC). In the power saving mode, the processing unit 10 operates only with the low-power clock function, for example. As a result, the average current consumption in the power saving mode is reduced to about 0.3 mA. The processing unit 10 sets a timer of a low-power clock (step S103). For example, the processing unit 10 sets a count value to a predetermined value (for example, a value corresponding to 500 ms) and starts down-counting, and enters a timer interrupt standby state (step S104).

The processing unit 10 determines whether or not the timer interrupt has occurred (step S105). For example, when the count value becomes 0 by down-counting, the processing unit 10 detects the occurrence of the timer interrupt (step S105: YES). In this case, the processing unit 10 performs the detection processing (step S106). Specifically, the processing unit 10 measures five samples for the sound pressure level of the external sound at a sampling frequency of 24 kHz. At this time, if the sound pressure level equal to or higher than the first threshold has not been detected (step S107: NO), the processing unit 10 resets the timer and returns to the timer interrupt standby state (steps S103 and S104). In this manner, the processing unit 10 performs the detection processing (step S106) at a cycle of 500 ms.

When the sound pressure level equal to or higher than the first threshold has been detected (step S107: YES), the processing unit 10 determines whether or not the external sound having a sound pressure level equal to or higher than the first threshold has been detected in n consecutive executions (for example, three executions) of detection processing (step S108). In a case where the external sound having a sound pressure level equal to or higher than the first threshold has been detected in one or two consecutive executions of detection processing (step S108: NO), the processing unit 10 resets the timer and returns to the timer interrupt standby state (steps S103 and S104). In a case where the external sound having a sound pressure level equal to or higher than the first threshold has been detected in three consecutive executions of detection processing (step S108: YES), it is likely to indicate a timing when a person starts talking, a timing when a conversation with a person starts, or a timing when hearing assistance is required to watch TV, for example. Therefore, the processing unit 10 transitions from the power saving mode to the normal operation mode and turns on the hearing aid function (step S109). The user can satisfactorily hear the external sound by the hearing aid function.

As described above, the processing unit 10 intermittently (for example, at a cycle of 500 ms) performs the detection processing of detecting the sound pressure level of the input external sound, and performs the output processing of adjusting and outputting the input external sound when the external sound whose sound pressure level is equal to or higher than the first threshold (an example of the first level) has been detected in all n consecutive executions (n is a natural number of 2 or more) of detection processing.

The processing unit 10 fades-in a sound output from the speaker 26 in order to prevent sudden fluctuations in the volume of the external sound heard by the user when transitioning from the power saving mode to the normal operation mode. That is, the processing unit 10 fades-in the adjusted external sound when transitioning from the power saving mode (an example of the first state in which the output processing of adjusting and outputting the input external sound is not performed) to the normal operation mode (an example of the second state in which the output processing of adjusting and outputting the input external sound is performed).

The processing unit 10 may monitor the timer interrupt by using an external RTC device connected to the processing unit 10 instead of the built-in RTC. Generally, the external RTC device is driven with low power. Therefore, also in this case, power saving of the hearing aid equipment 1 is ensured.

The processing unit 10 resets the timer and enters the timer interrupt standby state (steps S110 and S111). When the occurrence of the timer interrupt has been detected (step S112: YES), the processing unit 10 performs the detection processing (step S113). At this time, when a sound pressure level exceeding a second threshold (an example of a second level) has been detected (step S114: NO), the processing unit 10 resets the timer and returns to the timer interrupt standby state (steps S110 and S111). That is, the processing unit 10 performs the detection processing (step S113) at a cycle of 500 ms even in the normal operation mode.

When a sound pressure level equal to or lower than the second threshold has been detected (step S114: YES), the processing unit 10 determines whether or not the sound pressure level equal to or lower than the second threshold has been detected in m consecutive executions (for example, 10 executions) of detection processing (step S115). In a case where the sound pressure level equal to or lower than the second threshold has been detected in one to nine consecutive executions of detection processing (step S115: NO), the processing unit 10 resets the timer and returns to the timer interrupt standby state (steps S110 and S111).

In a case where the sound pressure level equal to or lower than the second threshold has been detected in 10 consecutive executions of detection processing (step S114: YES), it is likely to indicate a timing when the necessity of hearing assistance is low, for example, when the surrounding environment is quiet. Therefore, the processing unit 10 transitions from the normal operation mode to the power saving mode and turns off the hearing aid function (step S102). As a result, the power consumption of the hearing aid equipment 1 is reduced, and a continuous operation time of the hearing aid equipment 1 is extended. The second threshold is the same as the first threshold. The second threshold may be higher than the first threshold in order to prevent the hearing aid function from being frequently switched on and off with the mode transition.

As described above, the processing unit 10 continuously performs the output processing of adjusting and outputting the input external sound until the external sound having a sound pressure level equal to or lower than the second threshold (an example of the second level) is detected in the detection processing. When the external sound having a sound pressure level equal to or lower than the second threshold has been detected in all consecutive m executions (m is a natural number larger than n) of detection processing, the processing unit 10 stops the execution of the output processing.

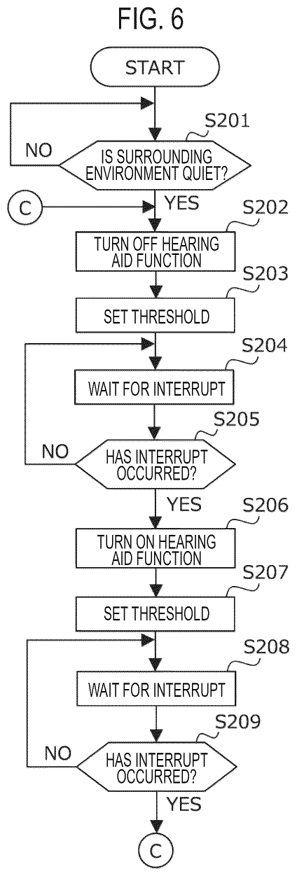

Processing performed by a processing unit 10 of a hearing aid equipment 1 in a second embodiment will be described with reference to FIG. 6. For example, when the hearing aid equipment 1 is powered on and operation in a normal operation mode is started, execution of the processing shown in FIG. 6 is started. For example, when the hearing aid equipment 1 is powered off, the processing shown in FIG. 6 ends.

The processing unit 10 determines whether or not the surrounding environment is quiet (step S201). When it is determined that the surrounding environment is quiet (step S201: YES), the processing unit 10 transitions from the normal operation mode to a power saving mode and turns off a hearing aid function (step S202). For example, a third threshold and a fourth threshold are held in advance in a storage unit 12. The processing unit 10 sets the third threshold held in the storage unit 12 as a threshold for an AD value acquired by the sound input unit 13 (step S203), and enters an interrupt standby state (step S204). The third threshold set here is, for example, a value corresponding to the sound pressure level of the first threshold in the first embodiment.

The processing unit 10 monitors the AD value and determines whether or not an interrupt has occurred (step S205). For example, when the AD value equal to or larger than the third threshold (that is, the value corresponding to the sound pressure level of the first threshold) is input, the processing unit 10 detects the occurrence of the interrupt (step S205: YES), transitions from the power saving mode to the normal operation mode, and turns on the hearing aid function (step S206). A user can satisfactorily hear an external sound by the hearing aid function. The processing unit 10 may monitor an input level of a microphone 20 by using a comparator circuit instead of the AD value.

The processing unit 10 sets the fourth threshold held in the storage unit 12 as a threshold for the AD value acquired by the sound input unit 13 (step S207), and enters the interrupt standby state (step S208). The processing unit 10 monitors the AD value and determines whether or not an interrupt has occurred (step S209). For example, when an AD value equal to or smaller than the fourth threshold set in step S207 is input, the processing unit 10 detects the occurrence of the interrupt (step S209: YES), transitions from the normal operation mode to the power saving mode, and turns off the hearing aid function (step S202). As a result, the power consumption of the hearing aid equipment 1 is reduced, and a continuous operation time of the hearing aid equipment 1 is extended.

In order to prevent the hearing aid function from being frequently switched on and off with the mode transition, in step S207, the processing unit 10 sets the fourth threshold to a value lower than the third threshold set in step S203. In order to more reliably prevent the hearing aid function from being frequently switched on and off, the processing unit 10 may detect the occurrence of the interrupt, transition from the normal operation mode to the power saving mode, and turn off the hearing aid function only when an AD value equal to or smaller than the fourth threshold is continuously input for a certain period of time.

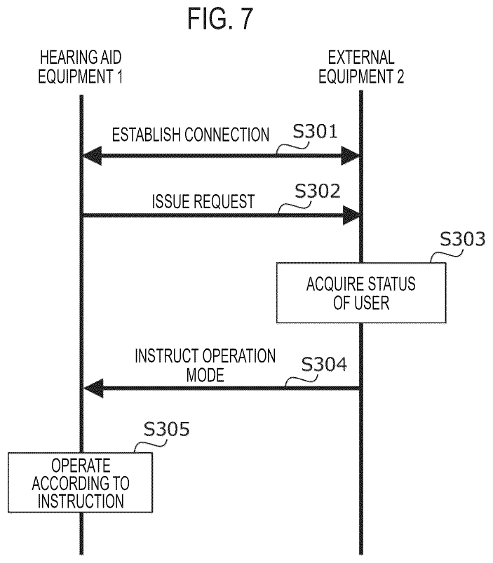

Processing performed in a system including a hearing aid equipment 1 and an external equipment 2 in a third embodiment will be described with reference to FIG. 7. In the third embodiment, the hearing aid equipment 1 attempts Bluetooth Low Energy (BLE) connection with the external equipment 2. In a power saving mode, the hearing aid equipment 1 periodically attempts the BLE connection with the external equipment 2 at intervals longer than those in a normal operation mode in order to save power.

When the BLE connection with the external equipment 2 is established (step S301), the hearing aid equipment 1 issues a request to the external equipment 2 (step S302). The hearing aid equipment 1 maintains the BLE connection with the external equipment 2 in any mode. In the power saving mode, the hearing aid equipment 1 may intermittently disconnect the BLE connection with the external equipment 2 in order to save power. In this case, the hearing aid equipment 1 is periodically reconnected to the external equipment 2 by interrupt processing using a low-power clock function such as an RTC, for example.

The external equipment 2 is, for example, a smartphone, and incorporates various sensors such as a global positioning system (GPS) sensor, an acceleration sensor, and a gyro sensor. The external equipment 2 periodically acquires various types of information such as a current position, a movement speed, and a movement direction of a user using such sensors. In the external equipment 2, an application App (see FIG. 1) dedicated to the hearing aid equipment 1 is installed.

The external equipment 2 executes the application App in response to a request from the hearing aid equipment 1. The application App acquires a status of the user in cooperation with various applications installed in the hearing aid equipment 1 (step S303). For example, the application App cooperates with a map application. In response to an inquiry from the application App, the map application acquires a status such as moving (for example, riding on a train) or working (for example, being in the office) based on the current position, the movement speed, and the movement direction of the user computed based on sensor outputs of the acceleration sensor, the gyro sensor, and the like, and a result of positioning processing using the GPS sensor, and returns the status to the application App. As an example, the map application determines whether or not two conditions (Condition 1: the user is continuously moving near a railway track (for example, a position within 10 m from the railway track) for several seconds, and Condition 2: the movement speed is several tens of km/h or higher) are satisfied based on the current position of the user acquired using the GPS sensor or the like. In a case where it is determined that the two conditions are satisfied, the map application acquires the status “riding on a train” and returns the status to the application App. The application App cooperates with a calendar application. In response to an inquiry from the application App, the calendar application acquires a status of the user based on a registered event (lunches, meetings, going-out, or the like) and a current time, and returns the status to the application App.

The application App instructs an operation mode of the hearing aid equipment 1 based on the status acquired in step S303 (step S304). For example, a case where the status “riding on a train” is acquired will be described. In many cases, there is no conversation with a person in a train. Therefore, the application App instructs the hearing aid equipment 1 to operate in the power saving mode. The instruction is periodically transmitted from the external equipment 2 to the hearing aid equipment 1 while the user is riding on a train. Therefore, the hearing aid equipment 1 that has received the instruction operates in the power saving mode while the user is riding on a train (step S305). Even in a case where a hearing aid function is turned off while the user is riding on a train, there is substantially no problem in grasping the surrounding situation for a person with mild or moderate hearing loss, the person wearing the open-fit hearing aid.

In the train, for example, an announcement is made at a timing of approaching the next station. In order to avoid missing such an announcement, the application App may instruct the hearing aid equipment 1 to operate in the normal operation mode at a timing of approaching a station. Since the hearing aid equipment 1 transitions from the power saving mode to the normal operation mode and the hearing aid function is turned on, the user can hear the announcement well. The application App can detect the timing of approaching a station by cooperation processing with the map application. For example, in a case where it is determined that Condition 3 (for example, a distance between the user and the next station is within several kilometers) is satisfied in addition to Condition 1 and Condition 2 described above based on the current position of the user acquired using the GPS sensor or the like, the map application notifies the application App that the timing of approaching the next station has arrived.

For example, a case where a status “moving by walking” is acquired will be described. The application App instructs the hearing aid equipment 1 to operate in the normal operation mode so that the user can safely walk by hearing a sound of a car, a bicycle, or the like. Since the hearing aid function is turned on during walking, the user can walk while hearing the surrounding sound well.

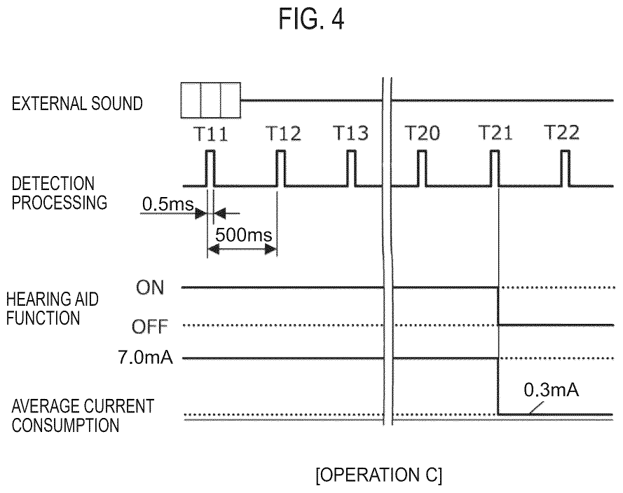

For example, a case where the status “being in the office” is acquired will be described. There may be various situations within an office. Therefore, the application App instructs the hearing aid equipment 1 to dynamically switch the operation mode between the power saving mode and the normal operation mode according to the surrounding environment of the user. The hearing aid equipment 1 that has received the instruction performs processing shown in FIG. 4 and the like, and dynamically switches the operation mode between the power saving mode and the normal operation mode according to the surrounding environment of the user (step S305).

For example, a case where a status “in a meeting” is acquired when a time for a scheduled event (such as a meeting) registered in the calendar application arrives will be described. In this case, the application App instructs the hearing aid equipment 1 to operate in the normal operation mode. The hearing aid equipment 1 that has received the instruction operates in the normal operation mode during the meeting (step S305). As a result, it is possible for the user to avoid missing any sounds during the meeting. That is, the hearing aid equipment 1 (processing unit 10) acquires an instruction based on a scheduled event (such as a meeting) set for the user from the external equipment 2, and continuously performs output processing (that is, continuously operates in the normal operation mode) during a time for which the scheduled event is set (for example, during the meeting) according to the acquired instruction.

In a case where the remaining capacity of the battery 30 is small, there is a possibility that battery depletion occurs under a situation where continuous operation in the normal operation mode is recommended, such as during a meeting. In this case, the application App may notify the user that charging of the hearing aid equipment 1 is recommended before a meeting or between meetings. The notification of the charging recommendation may be displayed as a message on the application App, or may be performed by sound reproduction. In addition, the hearing aid equipment 1 may receive an instruction from the application App and reproduce a notification for recommending the charging of the hearing aid equipment 1 by sound according to the instruction. The charging of the hearing aid equipment 1 before a meeting or between meetings may be registered as a scheduled event in the calendar application.

The application App may estimate whether or not the battery depletion occurs during a meeting based on the remaining capacity of the battery 30 (in other words, a drivable time in the normal operation mode) and the total duration of a meeting registered in the calendar application. In a case where it is estimated that the battery depletion occurs, the application App may notify the user that the charging of the hearing aid equipment 1 is recommended before a meeting or between meetings. The notification may be performed by the hearing aid equipment 1 by sound reproduction. As described above, the hearing aid equipment 1 (processing unit 10) may make a notification for recommending the charging of the hearing aid equipment 1 according to an instruction acquired from the external equipment 2 in a case where the total duration of a scheduled event (such as a meeting) is equal to or longer than a threshold (for example, the drivable time in the normal operation mode estimated from the remaining capacity of the battery 30).

The “battery depletion (that is, the remaining capacity of the battery 30 is 0%)” may be paraphrased as “approaching battery depletion (for example, the remaining capacity of the battery 30 falls below a threshold (such as 10%))” or the like. For example, in a case where it is estimated that the remaining capacity of the battery 30 falls below the threshold during a meeting, the application App or the hearing aid equipment 1 may make a notification for recommending the charging of the hearing aid equipment 1 for the user immediately after the meeting (or between consecutive meetings). The application App may register the charging of the hearing aid equipment 1 immediately after the meeting (or between the consecutive meetings) as a scheduled event in the calendar application.

In this manner, the external equipment 2 acquires the status of the user of the hearing aid equipment 1 (an example of the electronic equipment), and outputs an instruction to the hearing aid equipment 1 based on the acquired status. The hearing aid equipment 1 performs the output processing of adjusting and outputting an external sound or stops execution of the output processing according to an input instruction. The hearing aid equipment 1 can turn on the hearing aid function in a situation where the necessity of hearing assistance is high, and can turn off the hearing aid function in a situation where the necessity of hearing assistance is low to operate with low power, in cooperation with the external equipment 2.

The above description is a description of the exemplary embodiments of the present disclosure. The embodiments of the present disclosure are not limited to that described above, and various modifications can be made within the scope of the technical idea of the present disclosure. For example, the embodiments of the present disclosure also include contents obtained by appropriately combining the embodiments and the like exemplarily specified in the specification or obvious embodiments and the like.

When the hearing aid function is unnecessarily turned on due to noise or other noise sound, not only the power-saving performance is deteriorated, but also the noise or other noise sound is amplified, which may cause discomfort to the user. Therefore, for example, in the above-described embodiment, a condition that “an external sound whose sound pressure level is equal to or higher than the first threshold is human voice” may be added as a condition for transitioning from the normal operation mode to the power saving mode.

In this case, the processing unit 10 performs determination processing for an external sound whose sound pressure level is equal to or higher than the first threshold, the external sound being detected in the detection processing. In the determination processing, for example, the processing unit 10 performs frequency analysis on the external sound to determine human voice and performs speech recognition to determine human voice. The processing unit 10 transitions from the power saving mode to the normal operation mode and turns on the hearing aid function only in a case where the external sound is determined as human voice. By preventing the hearing aid function from being unnecessarily turned on, it is possible to improve the power-saving performance and to avoid giving discomfort to the user due to amplification of noise and other noise sound.

The processing unit 10 may perform the entire determination processing or may cause another device to handle a part of the determination processing. For example, the processing unit 10 may perform only processing of extracting a feature amount of the external sound that is necessary for speech recognition and cause a cooperating device (such as the external equipment 2) to perform the remaining processing of the determination processing. In this case, a processing load of the processing unit 10 can be reduced to achieve further power saving. In addition, a determination system can be improved by causing the external equipment 2 having a higher specification than the hearing aid equipment 1 to perform the remaining part (for example, speech recognition processing based on the feature amount) of the determination processing.

The processing unit 10 may transition from the power saving mode to the normal operation mode by a voice wake-up function and turn on the hearing aid function. A keyword (for example, “I can't hear”) for voice wake-up may be registered in advance in the hearing aid equipment 1, or the user may operate the external equipment 2 to register the keyword. The keyword is stored in the storage unit 12, for example. When a voice input of the keyword is detected, the processing unit 10 transitions from the power saving mode to the normal operation mode and turns on the hearing aid function.

In addition, a keyword for transitioning from the normal operation mode to the power saving mode and turning off the hearing aid function may be registered in the hearing aid equipment 1. When a voice input of the keyword is detected, the processing unit 10 transitions from the normal operation mode to the power saving mode and turns off the hearing aid function.

The external equipment 2 may perform voice wake-up. In this case, when the user murmurs the keyword for voice wake-up, the external equipment 2 transmits a command to the hearing aid equipment 1. Upon receiving the command, the hearing aid equipment 1 transitions from the power saving mode to the normal operation mode and turns on the hearing aid function.

What is claimed is:

1. An electronic equipment comprising at least one processor, wherein
the at least one processor:
intermittently performs detection processing of detecting a level of an input external sound, and
performs output processing of adjusting the input external sound and outputting the input external sound in response to the external sound whose level is equal to or higher than a first level being detected in consecutive executions of the detection processing performed intermittently.

2. The electronic equipment according to claim 1, wherein
the at least one processor continuously performs the output processing until the external sound whose level is equal to or lower than a second level is detected in the detection processing.

3. The electronic equipment according to claim 1, wherein
the at least one processor:
performs the output processing in response to the external sound whose level is equal to or higher than the first level being detected in n consecutive executions of the detection processing performed intermittently, n being a natural number of 2 or more, and
stops the output processing in response to the external sound whose level is equal to or lower than a second level being detected in m consecutive executions of the detection processing, m being a natural number larger than n.

4. The electronic equipment according to claim 1, wherein
the at least one processor:
fades-in the adjusted external sound in response to transitioning from a first state in which the output processing is not performed to a second state in which the output processing is performed; and
fades-out the adjusted external sound in response to transitioning from the second state to the first state.

5. The electronic equipment according to claim 1, wherein
the at least one processor:
acquires an instruction based on a scheduled event set for a user of the electronic equipment from an external equipment; and
continuously performs the output processing during a time for which the scheduled event is set according to the acquired instruction.

6. The electronic equipment according to claim 5, wherein
the at least one processor makes a notification for recommending charging of the electronic equipment according to the instruction acquired from the external equipment in a case where a total duration of the scheduled event is equal to or longer than a threshold.

7. The electronic equipment according to claim 1, further comprising:
a speaker; and
a microphone, wherein
the at least one processor:
sets the speaker to any one of a sleep state, a standby state, and a power cutoff state in a first state in which the output processing is not performed;
operates the microphone in response to the detection processing being performed and sets the microphone to any one of a sleep state, a standby state, and a power cutoff state in response to the detection processing not being performed, in a first state in which the output processing is not performed; and
causes the speaker to adjust the external sound and output the external sound in a second state in which the output processing is performed.

8. A system comprising:
the electronic equipment according to claim 1; and
an external equipment communicably connected to the electronic equipment, wherein
the external equipment:
acquires a status of a user of the electronic equipment; and
outputs an instruction to the electronic equipment based on the acquired status, and
the electronic equipment performs the output processing or stops the output processing according to the input instruction.

9. A method executed by a computer, the method comprising:
intermittently performing detection processing of detecting a level of an input external sound
performing output processing of adjusting the input external sound and outputting the input external sound in response to the external sound whose level is equal to or higher than a first level being detected in consecutive executions of the detection processing performed intermittently.

10. The method according to claim 9, further comprising:
continuously performing the output processing until the external sound whose level is equal to or lower than a second level is detected in the detection processing.

11. The method according to claim 9, further comprising:
performing output processing of adjusting the input external sound and outputting the input external sound in response to the external sound whose level is equal to or higher than a first level being detected in n consecutive executions of the detection processing performed intermittently, n being a natural number of 2 or more, and
stopping the output processing in response to the external sound whose level is equal to or lower than a second level being detected in m consecutive executions of the detection processing, m being a natural number larger than n.

12. The method according to claim 9, further comprising:
fading-in the adjusted external sound in response to transitioning from a first state in which the output processing is not performed to a second state in which the output processing is performed; and
fading-out the adjusted external sound in response to transitioning from the second state to the first state.

13. The method according to claim 9, further comprising:
acquiring an instruction based on a scheduled event set for a user of the electronic equipment from an external equipment; and
continuously performing the output processing during a time for which the scheduled event is set according to the acquired instruction.

14. The method according to claim 13, further comprising:
making a notification for recommending charging of the electronic equipment according to the instruction acquired from the external equipment in a case where a total duration of the scheduled event is equal to or longer than a threshold.

15. The method according to claim 9, further comprising:
setting a speaker to any one of a sleep state, a standby state, and a power cutoff state in a first state in which the output processing is not performed;
operating a microphone in response to the detection processing being performed and sets the microphone to any one of a sleep state, a standby state, and a power cutoff state in response to the detection processing not being performed, in a first state in which the output processing is not performed; and
causing the speaker to adjust the external sound and output the external sound in a second state in which the output processing is performed.

16. A non-transitory computer-readable recording medium in which a program is recorded, the program causing a computer to execute:
intermittently performing detection processing of detecting a level of an input external sound; and
performing output processing of adjusting the input external sound and outputting the input external sound in response to the external sound whose level is equal to or higher than a first level being detected in consecutive executions of the detection processing performed intermittently.
